(19) United States
(12) Patent Application Publication
(10) Pub. No.: US 2007/0156540 A1
(43) Pub. Date: Jul. 5, 2007

(54) Method and apparatus for re-configurable vehicle interior design and business transaction

(76) Inventors: Yoram Koren, Ann Arbor, MI (US); Jacob Barhak, Ann Arbor, MI (US); Zbigniew Pasek, Ann Arbor, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/326,069

(22) Filed: Jan. 5, 2006

(51) Int. Cl. G06Q 30/00

(52) U.S. Cl. 705/26

(57) ABSTRACT

The subject methods and apparatus allow the buyer of an automobile to configure and design a personalized interior space prior to purchasing the automobile. The buyer selects modular interior components from a library of choices provided by the manufacturer, and designs his/her custom automobile by using an interactive design domain system that allows realistic visualization of the developing interior with the incorporation of the buyer's anthropometric information. The method and apparatus guarantee conformance to applicable safety, geometric and functional constraints through the application of a rules-database. The produced automobile will fit exactly the customer's taste, physical dimensions, and personal requirements. The apparatus includes a computer that hosts a decision-support and feedback system, a database of safety, geometric and functional rules, and a database of interior components. The apparatus also includes a device for realistic visualization of the designed vehicle interior as well as suitable devices to measure the body dimensions that are needed for the design. A business transaction is contemplated in which the buyer custom-designs the vehicle interior using modular components after the sale transaction but before the manufacturing step.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The invention relates generally to a method and apparatus for designing a vehicle interior, and a method for conducting a vehicle business transaction with a customer in which the vehicle buyer has freedom to design the selection and arrangement of components within the vehicle's interior space and to subsequently reconfigure the interior space as needs and desires change over time.

2. Related Art

Since its birth some two centuries ago, the manufacturing industry has undergone several revolutions. Each revolution created a new manufacturing paradigm. The applicants have diligently studied the historical accounts and have developed a novel perspective in that each paradigm shared three common, basic elements: (1) Design: Designing the products and their functions to satisfy the buyer's requirements; (2) Make: Making the products by a process and a manufacturing system that can produce the products needed; and (3) Sell: Selling the products to customers in order to make a profit for the enterprise. The sequential order of these three elements changed depending on the paradigm and its particular business method and model. In modem times, the applicants have identified four major paradigms in consumer goods manufacturing: Craft Production, which eventually shifted to Mass Production, which then shifted to Mass Customization, and most recently the Personalized Production paradigm.

During the Craft Production paradigm, the product a customer asked for was made to order, usually one product at a time. The business sequence in this paradigm was Sell-Design-Make. First, the sale of the product was executed. Then the manufacturer and the buyer designed the product that fit the buyer's needs and taste. Finally, the product was made. Craft Production of automobiles was flourishing during the 19^{th} Century until the beginning of the 20^{th} Century. However, producing Craft automobiles today would be extremely expensive and could not be afforded by most consumers.

The Mass Production paradigm was characterized by the production of extremely high quantities of identical products. Because of these large quantities, products could be produced at a low cost. The business sequence in this paradigm was Design-Make-Sell, where the manufacturer was designing and making the products, hoping that they would later be sold to customers. “The customers will always be there to buy products” was the main assumption of Mass Production paradigm. Mass Production flourished as a paradigm during most of the 20^{th} Century.

What followed was the Mass Customization paradigm, a society-driven perspective that started in the late 1980s when customers asked for a larger variety in consumer products. A large number of product options became available during this era. According to this paradigm, the manufacturer decides on the basic product options, and the customer has to select the one that he/she prefers most, buy it, and then the product is made. The business sequence in this paradigm was Design-Sell-Make.

The Personalized Production paradigm, on which the subject invention is focused, is driven by globalization. With the excess production capacity created by globalization, high-quality products can be produced in many countries and become available to consumers all over the world. This circumstance created a situation in which the consumers have more power not only in choosing exactly the product that fits their needs and taste, but also in the ability to order and receive the product in a reasonable time. The dilemma of the manufacturer is how to make-to-order the product a customer is asking for, but to make it at affordable cost and a short time frame. In order to produce make-to-order products at affordable cost, this invention proposes to separate the product design into two phases: (1) Design of the product architecture and modules by the manufacturer, and (2) Design of the specific, personalized product by the customer using available modules. The business sequence for this paradigm is such that “Sale” precedes “Personalized-Design.” But the general product architecture and the product basic modules are designed prior to the sale. Consider for example a kitchen design that is based on standard-sized and available cabinet modules. The final tailored, personalized-design is done with the customer input after the sale. Therefore, the actual business sequence is: Design(A)-Sell-Design(P)-Make, where A stands for the product architecture design phase, and P stands for the personalized design phase in which the customer is involved. The common denominator between Craft Production and Personalized Production is that the customer (buyer) is involved in the design of his/her product such that it exactly fits their need, taste, function, and body dimensions.

Over the past two centuries marketing has turned full circle, i.e., from focusing on the individual, to focusing on the product, and now back to focusing on the individual customer in the Mass Customization paradigm and, to an even greater extent, in the Personalized-Production paradigm. The customer's role in relationship with the three basic elements—Design, Make, Sell—changes with each paradigm shift. The customer is at the forefront of the Design-Make sequence of the Craft Production paradigm (a pull-type model). The customer is, however, at the bottom of the sequence in the Mass Production paradigm (a push-type model). In Mass Customization, the manufacturer makes the main strategic decisions about the product basic architecture (e.g., a “platform” in the auto industry) as well as the number of variations and options. The customer can only select the option that best fits his/her preferences and price. The Personalized Production paradigm has a more complex sequence, and is the closest to that of Craft Production. These ideas are expressed in FIGS. 1 and 2, which both contain material which is subject to copyright protection. The copyright owner has no objection to the facsimile reproduction by anyone of these FIGS. 1 and 2 as part of the patent document or the patent disclosure, as they appear in the Patent and Trademark Office patent file or records, but otherwise reserves all copyright rights whatsoever.

Although the goal of both the Mass Customization and Personalized Production paradigms is to create a better fit between product offering and customer's preferences by producing “made-to-order” products, the strategic decisions that the manufacturer has to make are very different. In Mass Customization, the strategic economic decision that the manufacturer has to make is the number of variations and options. More variations add complexity and cost; but more variations increase the market of product buyers. In Personalized Production, however, the product has a modular architecture, and the economic decision is the number of product modules from which the customer can select their preferences and their structure. The Personalized Production paradigm provides the optimal involvement of the customer, when the level of involvement and product price are traded.

A sophisticated model of the Mass Customization paradigm is known as the “option package.” In the automotive industry, for example, once the initial auto manufacturing market leveled out from its extreme supply-driven mode, designers began looking for ways to offer products that were different from the norm but not so different as to significantly alter their costs or their manufacturing schemes. Car makers started offering sets or “packages” of options to appeal to various driving markets. There remained the “standard” option of a fully functional vehicle, but in addition there appeared a “sports model” and typically, a “luxury” edition as well. The sports model might offer a more powerful engine, different transmission, tires, wheels, seats, and a distinctive paint scheme. But from the manufacturer's point of view, the sports model was still largely the same car that they made for a family of four. The luxury edition attended more to comfort features which in the past included heating and air conditioning but also aesthetic improvements such as furniture wood and metal finished interiors, better sound dampened interiors and powered controls. The marketing of options packages which remains an active model, focuses more on the unique features being offered; and these features may or may not actually add significant cost to the end product. Options packages do add to a manufacturer's menu of offerings enabling them to reach markets that they otherwise could not without creating a whole new vehicle program. And, through the option package model, manufacturers are able to sell the packages at much higher markups to customers who want and are willing to pay for the novelty of those unique features.

In the option package model of the Mass Customization paradigm, many options are designed, but only the product with the option that is being ordered is made. The financial transaction with the customer (i.e., the Sell phase) occurs between the product design and the manufacturing (Make) phases. From the product design aspect, however this is still a push-type business model. But from the manufacturing aspect, it is a pull-type model (i.e., built-to-order). The combined design and manufacturing aspects thus create a push-pull type business model.

Offering a range of options was a significant step up in the marketing of products, but at this stage the option packages are just that-packages. A customer has only a limited number of option choices. In the example of an automobile, the buyer may have three or four options and then paint and upholstery color choices, and that is all. A customer cannot choose features from one package and mix them with features of other packages because it would cause significant strain on the marketing, distribution, and manufacturing systems that provide them. Most manufacturers cannot (or chose not to) try to accommodate the buyer's desire for more choices since doing so increases the complexity of their operations and reduces their profit on the end product.

With the Personalized Production paradigm, by contrast, products are made or assembled according to the specific personal needs of individual customers. A very basic example is the custom kitchen design. Considering room shape, window location, size, and illumination, each kitchen starts out unique. A given individual customer who has personal needs, budget, preferences and taste will use a kitchen differently than another customer—which adds another level of difference. However, kitchens are made with a technique that allows offering them at affordable prices. The technique divides the product Design process into two phases. The first phase includes the design of the basic building blocks, or modules, of the product (number, shape, color, material, etc.), and the general architecture that specifies how modules will be connected, interfaced, and integrated with each other in terms of mechanical (e.g., brackets, bolts, grooves, etc.), power (electrical, hydraulic, water, etc.), and information (sensor signals and controls). This first phase of the product design is done by the manufacturer, with possible cooperation from the component suppliers. Then the financial transaction—the sale to a customer—occurs. The customer is then involved in the second phase of product Design which is characterized as the personalized design phase. Based on a “library” of components or modules offered, together with the physical constraints, and the customer exercises their preferences and taste to arrive at a personalized design. Only then is the product (the kitchen in this example) manufactured. The four phases of this Personalized Production paradigm are shown in FIG. 2.

One of the basic differences between the paradigms of Mass Customization and Personalized Production can be observed in their respective output products. In Mass Customization there will be similar products in the market. With Personalized Production, on the other hand, almost every product is one-of-a-kind, because the customer is involved in his/her product design. The modular product design methodology found in the Personalized Production paradigm enables its low-cost advantages. An example may be seen from the preceding example of internal kitchen design, where each finished kitchen tends to look unique even though the basic building blocks—the kitchen modular cabinets—may be commodities coming from the same manufacturer.

### SUMMARY OF THE INVENTION AND ADVANTAGES

The subject invention comprises a method for selecting and placing modular components within the interior space of an unfinished motor vehicle by an individual retail buyer of the vehicle. The method comprises the steps of storing a plurality of vehicle interior space choices, where each space choice has a plurality of possible discrete placement locations. The method also includes selecting one interior space from the plurality of stored space choices, storing a plurality of modular component choices in an electronic database library, selecting one component from the plurality of component choices in the library, placing the selected component in the selected interior space in one discrete placement location, simulating the interior space in scaled depiction on a Graphic User Interface with the selected component positioned in the discrete placement location, determining whether the placement of the selected component complies with a predetermined constraint, and communicating non-compliance with the predetermined constraint directly to the buyer as feedback information.

The subject invention capitalizes on the unique advantages within the emerging Personalized Production paradigm and applies these concepts to the customer-enabled design of vehicle interiors. Due to the sophisticated and safety-sensitive nature of vehicular transportation, however, the buyer-directed placement of selected components within the interior space is checked for compliance with a predetermined constraint, such as a safety constraint, a geometry constraint, and/or a functional constraint. By this technique, an unsophisticated vehicular buyer is enabled to custom-design the interior space of a motor vehicle which will later be manufactured to their specifications.

According to another aspect of the invention, a method for designing and personalizing the selection and placement of modular components within the interior space of an unfinished motor vehicle passenger compartment is provided. The method comprises the steps of providing a retail motor vehicle buyer having at least one anthropometric characteristic, measuring the buyer's anthropometric characteristic, providing a Graphic User Interface of the type capable of displaying a scaled graphical representation of physical objects, storing a plurality of modular component choices in an electronic database library, selecting one component from the plurality of component choices in the library, positioning the selected component in the interior space in one discrete placement location, displaying on the Graphic User Interface a dimensionally scaled graphical representation of the selected component in the discrete placement location in the interior space, displaying on the Graphic User Interface a dimensionally scaled graphical representation of the buyer in a seated driving position in the interior space, calculating the minimum distance between the buyer and the component based on the measured anthropometric characteristic, and displaying the calculated minimum distance on the Graphic User Interface so that the buyer may contemplate their estimated special relation to the component and re-position the component within the interior space, under specified constraints, to another discrete placement location if the calculated minimum distance is deemed unsatisfactory.

According to a further aspect of the invention, a business method is provided for conducting a vehicle business transaction with an individual retail buyer of a motor vehicle. The method comprises the steps of providing the buyer with a plurality of vehicle interior space choices, each space choice having a plurality of possible discrete placement locations, providing the buyer with a plurality of modular component choices, soliciting the buyer to select and place at least one modular component within the interior space of the motor vehicle prior to the vehicle being manufactured, determining whether the buyer's placement of the selected component complies with the predetermined constraint, and communicating non-compliance with the predetermined constraint directly to the buyer as feedback information.

According to yet another aspect of the invention, a business method is provided for conducting a vehicle business transaction between a seller and an individual retail buyer to guarantee a unique motor vehicle interior design. The method comprises the steps of providing the buyer with a vehicle interior space having a plurality of possible discrete placement locations, providing the buyer with a plurality of modular component choices, soliciting the buyer to select and place at least one modular component in a discrete placement location within the interior space of the motor vehicle prior to the vehicle being manufactured, completing the vehicle interior design, making a record of the completed vehicle interior design, and excluding the completed vehicle interior design from future vehicles offered by the seller to other buyers.

The subject method and apparatus allow the buyer of an automobile to configure and design a personalized interior for an automobile before purchasing it. The automobiles may be a vehicle of any type and for any application, such as a luxury car, sedan, minivan or SUV. The buyer can select modular interior components from a library of modules provided by the manufacturer, and design his/her personal car by using an interactive design domain system that allows realistic visualization of the selected car interior with the incorporation of the customer's anthropometric information. Furthermore, the method guarantees conformity to safety, geometric and functional constraints that are stored in a database of corresponding rules. The custom-produced car will fit exactly the customer's taste, physical dimensions, and requirements.

The subject apparatus includes a computer that hosts a decision-support and feedback system, a database of safety, geometric and functional rules, and a database of interior components. The apparatus also includes means for close-to-real visualization of the vehicle interior, as well as means to measure the buyer's body dimensions that are needed for the design.

The invention introduces also a business method, which implements the sequence Design(A)-Sell-Design(P)-Make, where A stands for the product architecture design phase, and P stands for the personalized design phase in which the customer is involved. This business method assures sales based on elevated value of the product as perceived by the customer. Yet, another business advantage of the method is that it is possible to guarantee the uniqueness of a one-of-a-kind interior design and configuration (at the sale time) and ask for higher price for this uniqueness of the product sold. Another aspect of the subject business method is selling open-ended products that could be reconfigured by the buyer in the future to accommodate future changing needs and preferences.

### BRIEF DESCRIPTION OF THE DRAWINGS

These and other features and advantages of the present invention will become more readily appreciated as the same becomes better understood by reference to the following detailed description when considered in connection with the accompanying drawings, wherein:

FIG. 1 is a flow diagram depicting the sequence of the main functions of a manufacturing enterpris—Design; Make; Sell—in four different paradigms, and shows for each paradigm the customer placement in this sequence and the customer role;

FIG. 2 is a pair of flow charts comparing the sequence of the main functions of two manufacturing paradigms—Mass Customization and Personal Production—showing the different business method of each paradigm, and the different role that the customer plays in each of these paradigms;

FIG. 3 is an illustrative view depicting the system and method of this invention, in which the buyer selects components from a database of interior modular components and places them in the open space of a car interior, and can immediately visualize an accurately scaled simulation of the buyer in the designed car interior;

FIG. 4 is an illustrative view depicting the details of the Interactive Design Domain System including the five major modules of the subject method together with a feedback loop that considers the customer's satisfaction with the placement and arrangement of components in the interior space;

FIG. 5 is a diagram showing the details of the Decision-Support and Feedback module, the integration of this module within the entire system and the integration of the car models and car interior components databases into the buyer's Design Domain;

FIG. 6 is a diagram representing the various functional units contained in the Interactive Design Domain System of FIG. 4, with the units grouped by category;

FIG. 7 is a flow chart showing the detailed steps of a preferred method of this invention;

FIG. 8 is an exemplary screen shot of a Graphic User Interface according to the invention;

FIG. 9 depicts a scaled simulation of the buyer interacting with components in the vehicle interior, together with a bar graph in which the buyer's comfort level estimation is checked at several typical postures and displayed for different body parts to provide feedback on which motions are outside a pre-defined comfort zone;

FIGS. 10A-D are top views of exemplary vehicle interiors generated according to the subject method to fit the personalized needs of different buyers; and

FIG. 11 is an illustration of the subject apparatus which includes a computer, simulator, visualization devices, a screen to display the design results and simulations of the human model in the car, input devices and a camera or a scanning device that takes photos of the buyer's anthropometric dimensions.

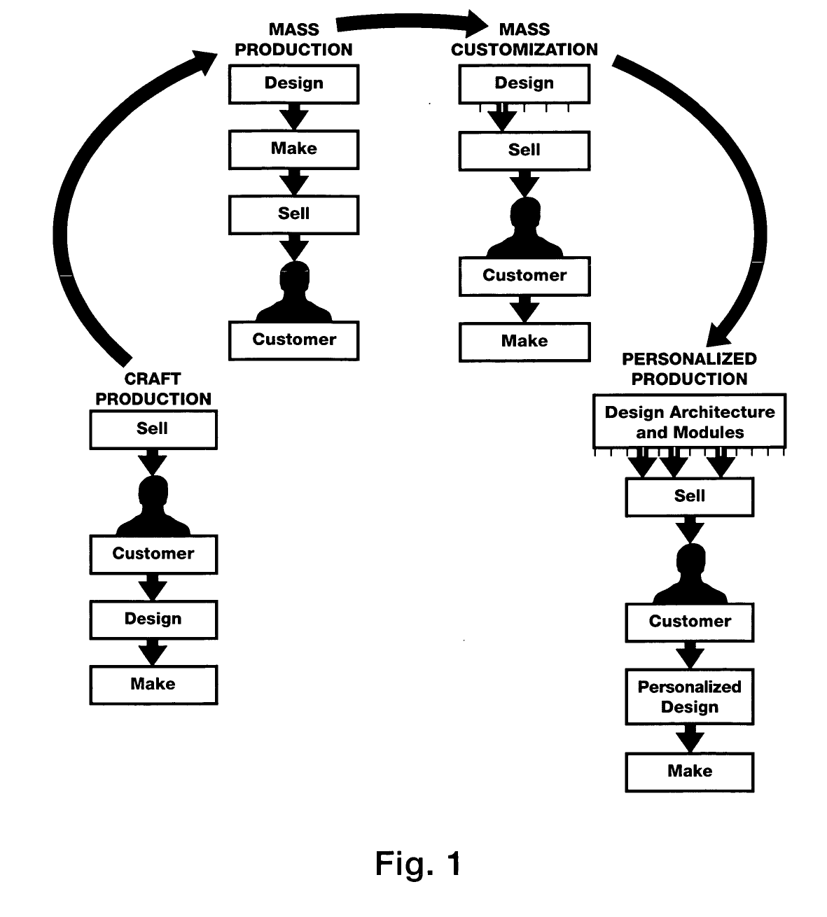

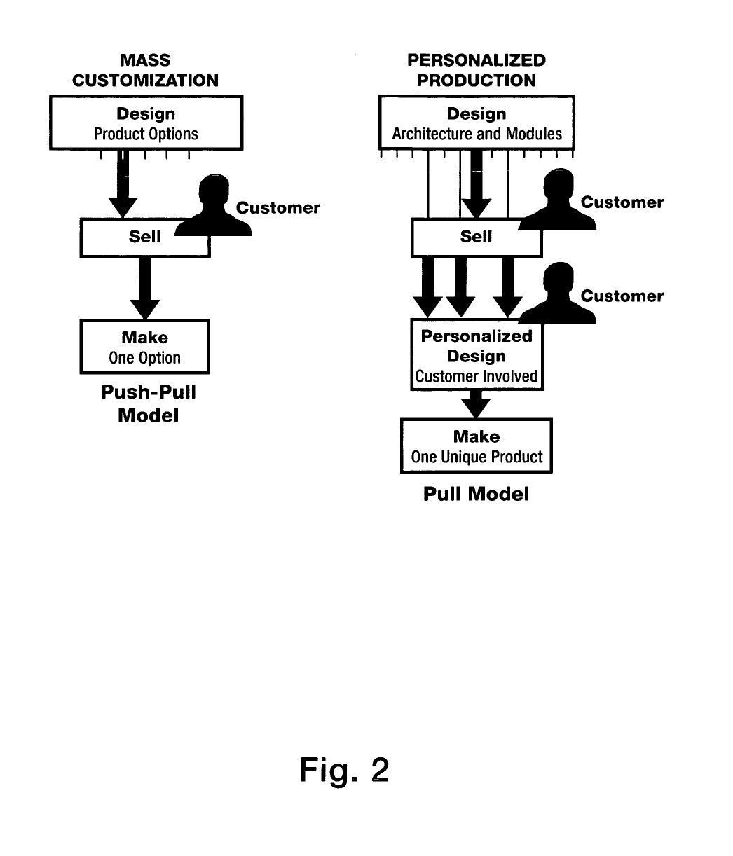

### DETAILED DESCRIPTION OF THE PREFERRED EMBODIMENT

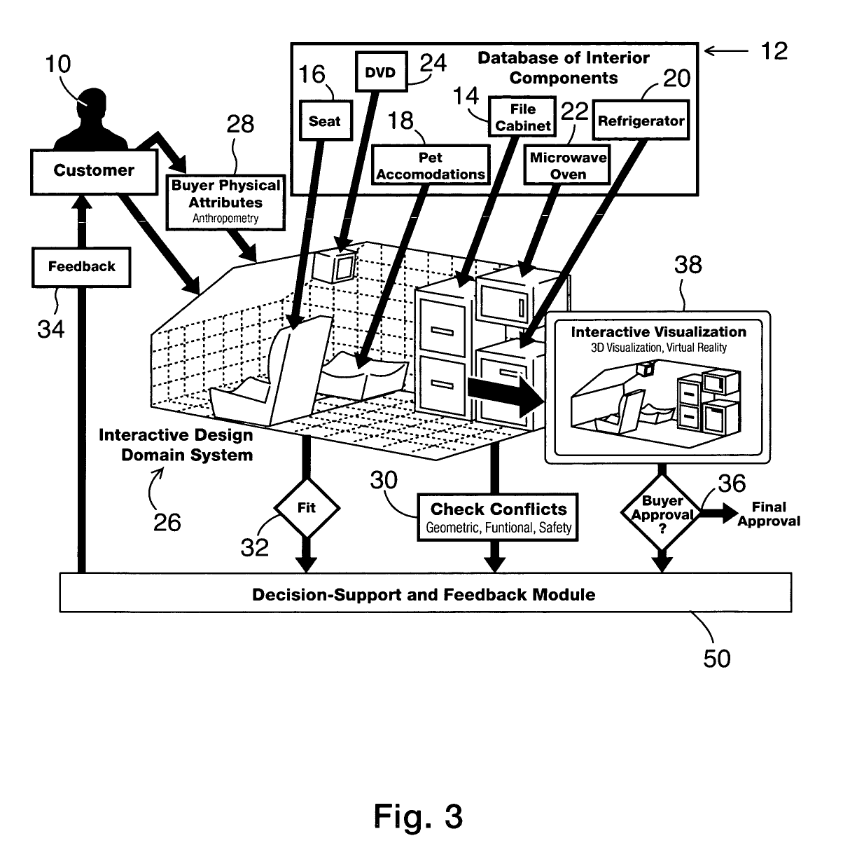

Referring to FIGS. 3-11, wherein like numerals indicate like or corresponding parts throughout the several views, the method of this invention is shown enabling a customer 10 to design the interior of an automobile before purchasing it, such that the automobile interior is tailored exactly to the buyer's individual personal needs, yet conforms to predefined safety and geometry constraints. According to the subject method, the manufacturer designs the architecture of the vehicle (e.g., installing rails to which components can be attached for safety). The manufacturer also creates a database library 12 of pre-determined possible modular interior components, such as file cabinets 14, seats 16, dog baskets 18, refrigerators 20, microwaves 22, and entertainment options 24, to name but a few. This library may be accessed remotely over the Internet or stored in a computer or on a stand-alone computer network.

The manufacturer also creates a set of allowed usage constraints. These constraints are of three types: safety (such as unsafe seat position), functional (such as not enough electric power to support the particular combination of devices), and geometry (such as not enough leg room). A conflict check 30 is made by the system to determine conformity with these geometry, function and safety constraints. Then, the customer 10 generates a personalized car design by selecting components and placing them around the interior of a virtual automobile using an Interactive Design Domain 26 which exists as an image on a Graphical User Interface (GUI). A fit check 32 to the buyer's physical attributes 28, which are entered by the apparatus, is also repeatably tested by the method. This process is repeated (as feedback 34) until the buyer's final approval 36 is achieved. The final approved design is stored digitally and sent to a car manufacturer, who uses the digital information to manufacture a vehicle matching the design criteria.

The Interactive Design Domain System 26 allows the buyer 10 to select a car model and its displayed interior space (from a corresponding database), to place and orient the chosen interior components (from a library 12 of components) within the car interior space, place them in a preferable location and arrangement, enter the buyer's important body dimensions 28, and view the result both in a stationary 2-D and in a simulated motion (3-D) environment 38. To protect privacy, the personal information is not stored when the design is completed, unless requested by the buyer.

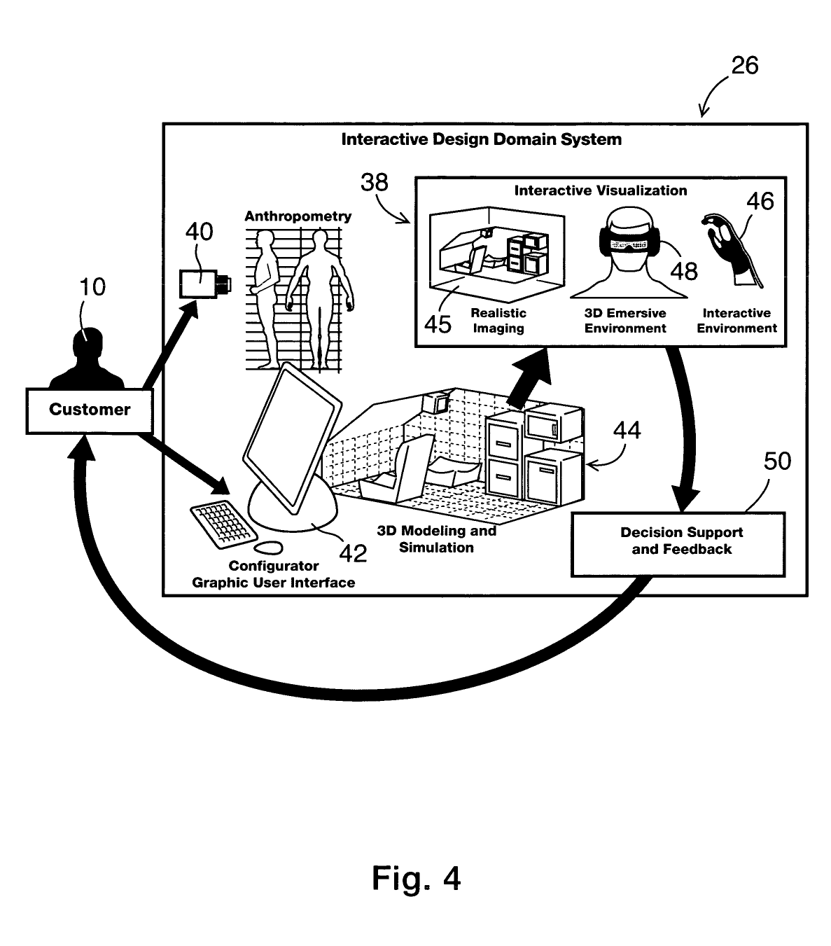

Within the Interactive Design Domain System 26, the customer 10 interacts with several modules as shown in FIG. 4. The Interactive Design Domain System 26 includes an anthropometry module for handling acquisition of anthropometric measurements from the customer 10, or other intended passengers, through one or more interfaces such as a camera 40, a scanner, analyzing an existing photograph, or via direct user input. For example, the apparatus of this invention may take a photo of the buyer 10 sitting on a car seat, and the length of his/her hands can be measured. Specialized software algorithms process the input information to produce the body measurements in a way that can later be processed by other modules.

The Interactive Design Domain System 26 also includes a Configurator GUI module which provides an easy to use Graphic User Interface (GUI) 42. With this interface 42, the customer 10 can design the car interior. The customer 10 selects interior components from the library 12 of components offered by the manufacturer. These components can be placed and arranged in the car interior space. A graphic symbol of an Interactive Design Assistant may be provided to help the customer 10 by providing hints, suggestions and answers. The customer 10 may choose to work on a simplified 2D sketch that helps with comprehending the schematic design.

A 3D Modeling and Simulation module collects the information on the design from the Configurator GUI and the human measurements from the Anthropometry module. A 3D model of the car interior and its intended occupants is then generated. This module also simulates the interaction amongst the different components and the occupants of the car. Simulations may be generated by customer request or by following predetermined rule sets. The output of the simulations can then be passed to the Interactive Visualization module, which generates 3D images 38 and movies that allow the user 10 to view and comprehend the abilities and limitations of the proposed custom design. Virtual reality techniques and apparatus 46, 48 may be used to enhance visualization. The display information 38 can be augmented with analysis information provided by the simulation module. This module can be integrated with the Configurator GUI to provide instant feedback to the customer. Alternatively this module can be launched in a different environment with advanced interfaces, such as an automobile simulator with haptic devices, a VR helmet, and powerful graphics hardware that can improve the realism of the images.

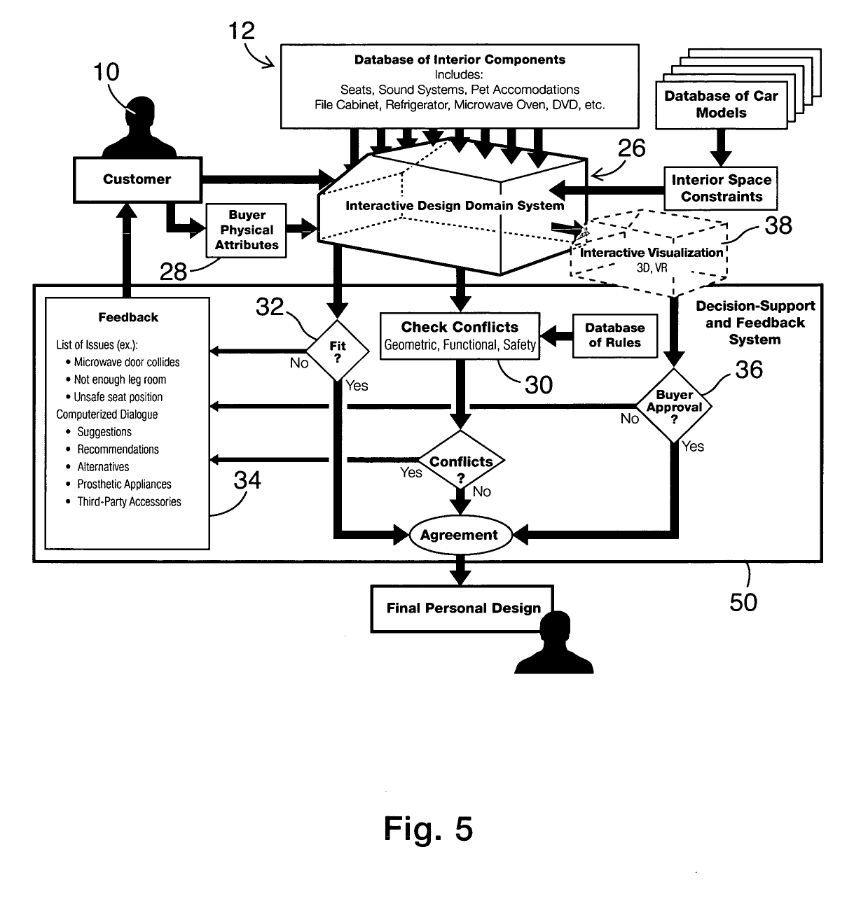

A Decision-Support and Feedback module 50 has two complementary tasks: (1) check the correctness and suitability of the design, and (2) list issues detected through these checks and suggest corrective actions, useful advice, and design alternatives. The Decision-Support and Feedback module is shown in extended detail in FIG. 5. There are three categories of checks that the Decision-Support and Feedback method executes. First, is a Buyer Approved check 36. This query determines whether the design is agreeable and satisfactory to the buyer's taste and needs, which depends on the buyer's personal judgment. This is the first feedback loop, which is solely dependent on the buyer's decision. Second, a fit check 32 is made to ascertain whether the design fits the buyer's physical attributes (such as the arm length to operate the radio and other panel controls, or reachability to other interior components). This is the second feedback loop in which the convenience level of the future user (and possibly also a passenger) is tested, and feedback advice is provided and intended to offer useful information for the next iterative step of the design. To assist the evaluation of the user's comfort level, the anthropometry information 28 (based on the measurements of the buyer's body) is utilized in the system to measure (i.e., estimate) convenience levels when the body is in motion. Third is the conflict check 30. Here, a determination is made against possible geometric, functional and safety conflicts, e.g., not enough leg room, or not an appropriate clearance to open the refrigerator door, or the seat is facing an unsafe direction, or some selected components cannot fit together in the interior space. Possible conflicts are tested in a systematic way against a database of geometric, functional and safety rules. With this method, the system can detect interferences among moving parts, automatically check for design conflicts, and check safety violations. The rules that are stored in a rules-database are not allowed to be violated, and the system will force the user to continue the interactive design process until there is no violation of any geometric, functional and safety constraints. If one or more of these three tests fail, the system notifies the user (i.e., the buyer 10), explains the issues detected, and even suggests design alternatives.

The Interactive Design Domain System 26 allows the buyer 10 to custom-design the interior of his/her future automobile by a step-by-step interactive procedure where each step is checked by the method. With this interactive procedure, the future user of the vehicle designs the interior in detail, such that it exactly fits his/her needs and taste, thereby satisfying aesthetic taste and philosophical principles. And the computerized system guarantees that geometric, functional and safety constraints are not violated.

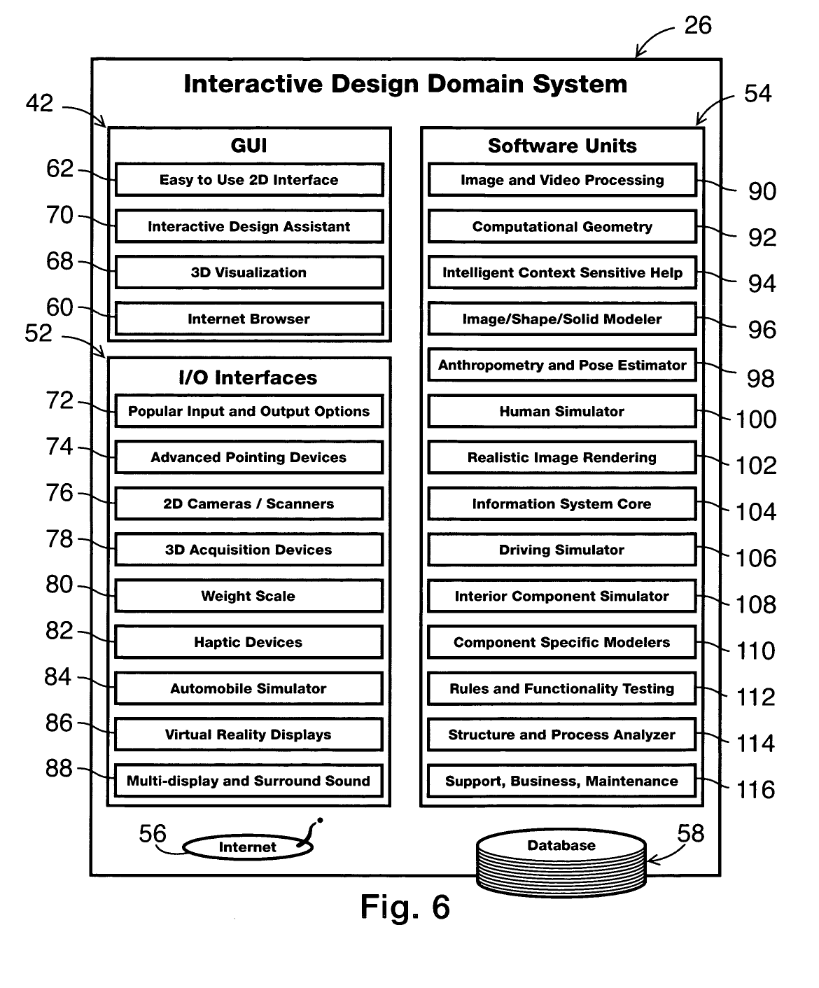

To support implementation of the Interactive Design Domain System 26, several components are required as perhaps best shown in FIG. 6. These components can be categorized into five groups: GUI 42, I/O interfaces 52, software units 54, as well as connectivity to the Internet 56 and to a database 58. These components can be used by one or more of the modules listed above.

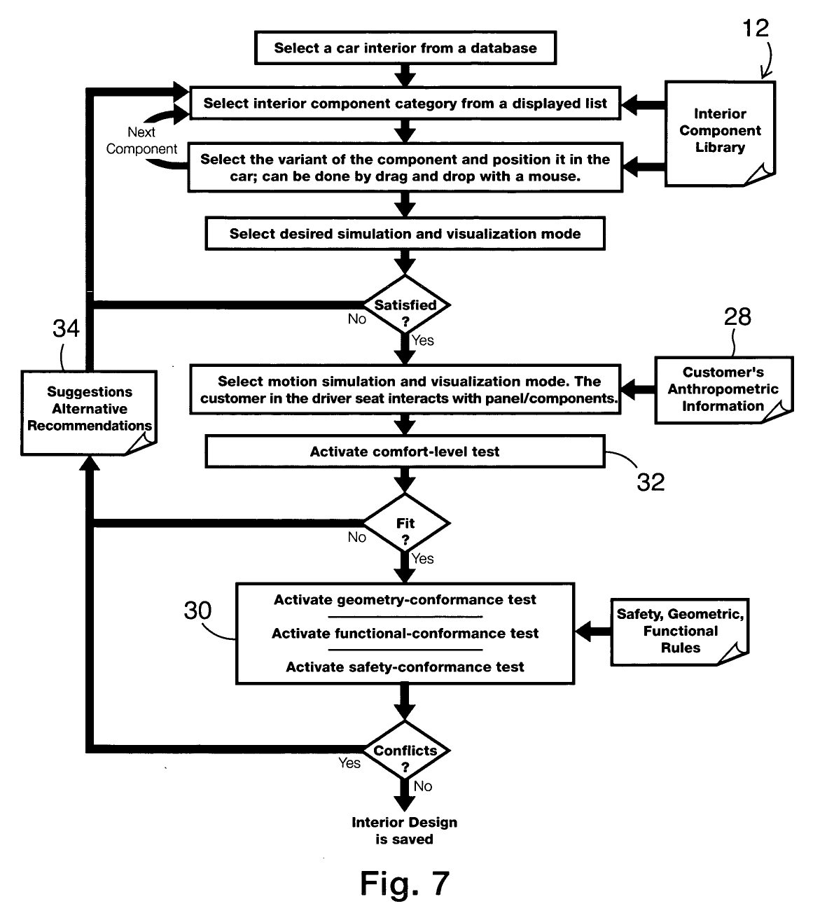

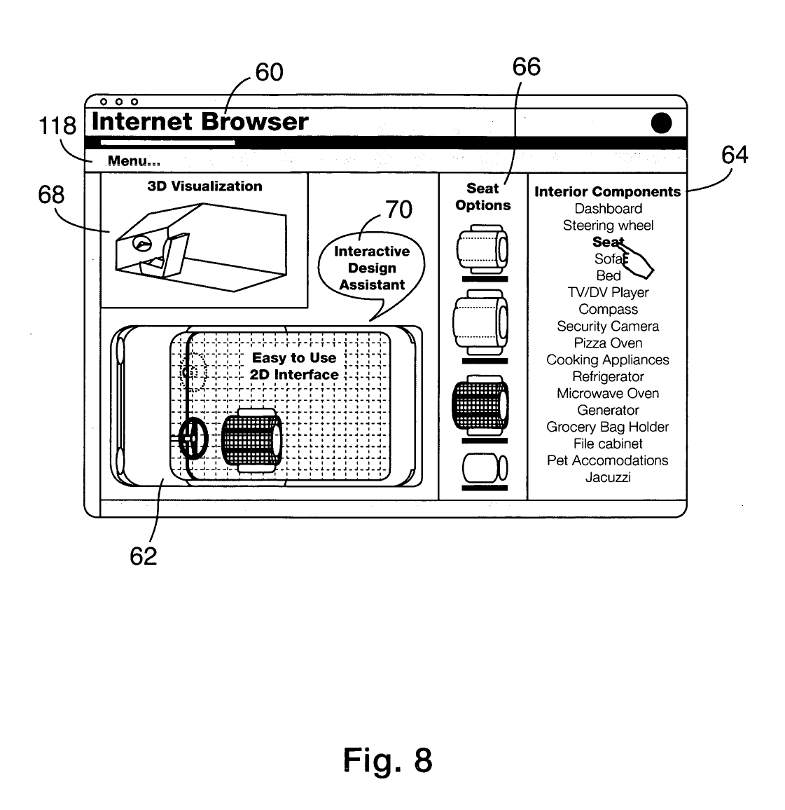

The Graphic User Interface (GUI) 42 allows the user 10 to easily and naturally interact with the Interactive Design Domain System 26. Such an interface 42 will preferably use a windows-based approach such as the ones found in Mac OS X or Microsoft Windows. This interface mainly provides functionality to the Configurator GUI module and the interactive visualization module. FIG. 7 illustrates practical usage of this GUI 42 by a user 10 through a workflow diagram. An illustrative example for an appearance of such a GUI 42 is presented as a representative screen shot in FIG. 8. This interface 42 is composed of several main sub-systems as shown in FIG. 6. Namely, an Internet Browser 60 is provided. The GUI 42 is integrated with a web browser 60 to allow internet connectivity. One way to allow this is to program the GUI 42 as a web plug-in. This allows communication and exchange options such as saving a car design, publishing it in a web page, sending it to a friend by email, or loading a car design created by another. Internet browsers 60 are available commercially. In addition, the sub-systems include an easy to use 2D interface 62. This 2-D interface 62 allows the user 10 to view a schematic representation of the car as it is being designed. The user 10 can select from a list of interior components 64 and from different options 66 provided for each such component. The user can drag and drop the selected component into any one of the available places in the 2-D car interface 62. The user 10 can also rearrange the components in the car 62 and remove components from a design. The menu allows the user to access other software units and I/O interfaces in the same or in another window.

Another sub-system comprises 3D visualization. Here a 3D model 68 of the car could be displayed, at the user's request, for realistically visualizing the constructed car. The 3D viewer includes traditional characteristics of 3D viewers. For example, the model 68 can be rotated and viewed from different vantages. Furthermore, some components of the car can be made to disappear or be transparent to allow visualizing its interior. Dragging interior components into the 3D model 68 may be allowed. However, this option is not recommended as orientation in 3D is not as natural as dragging and dropping to the 2D interface 62. Libraries and tools to support 3D visualization are available commercially.

Finally, the GUI sub-system also includes an interactive design assistant 70. This interface 70 provides guidance to help the new user, who is unfamiliar with the system, to become familiar with the software. This assistant 70 can provide a walk-through for the user 10 by moving along the screen and providing instructions and hints. The assistant 70 is intelligent in the sense that it adapts to the user's actions. It provides help in case the user requests it or if it detects that the user is not succeeding in a task. The assistant 70 can suggest frequently chosen designs to save time. The design assistant 70 is similar in a sense to the office assistant existing in applications such as Microsoft Office, but with a focus on automobile interior design.

The Interactive Design Domain System 26 can access to numerous commercially available Input and Output options 52, both traditional and specialized. Access can be gained through the use of appropriate operating system functions, specific driver software components and appropriate hardware interfaces. Software units that require specific input/output methods can use these interfaces. Such options 72 may include input and output interfaces common in everyday life like keyboard, mouse, monitor, speakers, internal and external data storage devices, printers, and common I/O hardware ports. Advanced pointing devices 74 that allow functionality beyond that of a mouse can be utilized. Such devices may include: a joystick, a space ball, or a 3D mouse for visualization, simulation and modeling tasks, a digital pen for artistic and drawing tasks, a touch screen to aid in interactivity and allow novice users to interact with the system and its units, or other advanced commercially available pointing devices.

I/O Interfaces 52 may also employ 2D cameras/scanners 76. The system can access commercially available digital cameras and scanners in order to acquire 2D images and video sequences from the outside world. Such images might include: people, drawings, patterns, pictures, colors, documents, and other images required in the process. These pictures are then made available to the system and its units. In order to import 3D shapes from the physical world, the system can access commercially available 3D acquisition devices 78 such as laser scanners, 3D cameras and touch probes. This allows acquiring 3D information on the shape of a person, or an object, and then passing these to appropriate units within the system.

Some units within the system, such as the human simulator, may require information on mass. A weight scale 80 may be used, for example commercially available scales, to enable access to weight information. In addition, haptic devices 82, in the form of commercially available tactile and force feedback devices, can be implemented to allow the customer to experience difficulties, while designing the interior and during the product simulation. An automobile simulator 84 can be incorporated to simulate the driving experience for the customer. Such a simulator may be either integrated with virtual reality devices 86 or have physical presence and rely on large displays. Pedals, a steering wheel, and gear shifts with adjustable positions may be part of this simulator 84. To support visualization and simulation of the designed vehicle, the system can access various virtual reality devices 86 such as: Cave, Geowall, VR Helmets, 3D monitors, 3D Glasses, Display software viewable by dual color glasses. 3D printers also fall into this category as these can rapidly prototype a full or scaled model of the designed car that the customer can consider before manufacturing the actual car. Furthermore, the system can support multi-display and surround sound 88 for demonstration, ease in design, visualization, and simulation. This allows splitting windows or showing the same contents spread over multiple displays.

The system can access various software units 54 consisting of libraries and applications. These software units 54 may also mutually interact amongst themselves. The units 54 can provide the following functionality by way of examples only and not of limitation. An image and video processing unit 90 includes 2D image processing and video processing functions that allow manipulation of 2D images and video sequences and their color components. Functions that extract information from the image such as edge detection, shape detection, OCR and other techniques are also included to provide processed information. Such units are commercially available. A Computational Geometry unit 92 includes computational geometry tools and data structures to allow representation of geometrical entities, and to optimize performance of the algorithms. Primarily it allows reconstruction of 3D shapes from 2D images and three-dimensional range images. It interprets the information acquired by the 3D scanners 78 and makes it available to other units dealing with 3D shapes such as the human simulator 100 or the solid modeler 96. In addition, this unit 92 contains functions such as finding the shortest path on meshes, mesh optimization, mesh smoothing, collision detection. Such units are commercially available and have been reported in the publically-known literature.

An intelligent, context-sensitive help unit 94 provides algorithms that drive the interactive design assistant. Statistics on the commonality of use of various features in the system allows this unit 94 to provide the most relevant help for a situation. Analyzing behavior patterns of the user 10 allows this unit 94 to distinguish between novice and expert users and provide help in the correct context. It also contains a guided walkthrough that demonstrates the system and its units. An Image/Shape/Solid modeler unit 96 allows modeling of shapes and images in 2D and 3D. 2D shapes and patterns can be used as textures and decorations in the automobile interior. 3D objects and their parameters can be modeled to allow changes in the design within permitted parameters. Software applications that perform these tasks are commercially available. An anthropometry and pose estimator unit 98 contains algorithms specific to estimate anthropometric information and human pose from images, video sequences, or 3D images models. The unit 98 includes algorithms for human body part detection in an image and can access anthropometric databases. Methods that deal with these issues have been reported in the public literature. The information generated by this unit 98 can be used beyond the system and be embedded within the constructed vehicle to allow the vehicle to recognize the driver and passengers and adjust itself to their predefined preferences if such technology exists in the car.

A human simulator unit 100 may also be included. With the aid of this unit 100, a scaled human figure with predefined anthropometric information can be placed in the designed interior and simulated to allow testing the design. Testing functions may include: visibility, reachability, comfort, usability, and forces. The user 10 may control the simulation type and parameters. Output can be provided in the form of movies reports and interactive visual representation. Software applications that perform these tasks are commercially available. A realistic image rendering unit 102 provides algorithms to support realistic rendering of the designed automobile and the human model. This includes proper lighting, texture mapping, transparency, reflection and shading algorithms to allow the user 10 to realistically visualize the designed vehicle before it physically exists. Software applications that perform these tasks are commercially available.

An information system core unit 104 serves as an interface between all the other sub systems and the database 58. It contains forms, rules, and queries that allow managing the information in the system. It provides support for the entire lifecycle of the vehicle: design, purchase, manufacturing, maintenance, and recycling. This unit 104 contains support for functions such as: status indicator, cost calculator, delivery information, identification & purchasing, and save options. The technology for constructing such a unit 104 is commercially available. A driving simulator unit 106 supports the ability of the user 10 to experience the designed car on the road in a virtual environment. It can interact with the automobile simulator 84 if it is used. Software applications that perform these tasks are commercially available. An interior component simulator 108 allows simulating the behavior of each interior component in the designed vehicle. This is accomplished by a separate software unit accompanying each component that plugs into the interior component simulator 108. This simulator 108 can then be used in conjunction with other simulator units to increase the reliability of the simulation. These units are externally constructed, using existing technology, with a focus on a specific component.

Some interior components may allow additional customization by the user. A component specific modeler 110 is a software component that allows guided manipulation of these interior components. One example is a seat modeler that allows changing the color and type of the seat covers. Another example is a dashboard modeler. These units are externally constructed, using existing technology similar to that of the main system, but with a focus on a specific component. These units can be plugged in and out of the system, depending on the availability of interior components offered by the manufacturer.

A Rules and Functionality testing unit 112 includes rule generation language and an associated dictionary that allows constructing rules similar to a computer language. The generated rules describe permitted and banned combinations and positions of the interior components. Other generated rules support detection of conflicts between components due to safety regulations, physical proximity, sensitivity to temperature, humidity, electrical components, light and radiation, and collision detection of moving parts existing in different components. The rule generation language and dictionary can be enriched with the addition of new interior components by the manufacturer. This can be accomplished by two methods: 1) through the direct use of commercially available scripting languages that support modeling and simulation applications and 2) through the definition and maintenance of a specialized rules generation language which allows creation of rules that can be used by the system.

A Structure and Process Analyzer unit 114 allows mechanical analysis of the designed vehicle and prepares the design for the manufacturing process. This unit 114 aids in generating information such as manufacturing time that is provided as feedback to the customer. Software tools that support such tasks are available commercially. A Support, Business, Maintenance unit 116 provides interfaces and models that support the designed product. Functions of this unit include: Remote human assistance, access to a help desk, maintenance scheduling, long term relationship between the customer and the manufacturer/dealer/maintenance provider. It can serve as a long term feedback mechanism that allows improving design, manufacturing, maintenance and recycling operations. Systems that offer such functionality are commercially available.

The system can be used remotely or use remote data via the Internet 56. Common interfaces may include a web browser, email messaging, chat rooms and other commercially available internet tools. The information required and gathered by the Interactive Design Domain System 26 is stored in the database 58 and held for the entire lifecycle of the product. Such information may include: information on the interior components, the interior car designs, customer database (as allowed by law and according to customer's preferences), financial transactions, manufacturing information, and maintenance information. Database tools are commercially available by companies such as Oracle and Microsoft to name but two.

A detailed flow chart of the method by which the buyer 10 can design the automobile interior is depicted in FIG. 7. The design is initiated by selecting the desired components and placing them in a preferred location, followed by an automatic check of possible conflicts and rule violations.

An exemplary screen shot obtained with the subject method may appear as shown in FIG. 8. In this Figure, an Internet browser 60 is hosting the easy-to-use 2D interface 62 in which the user 10 selects interior components 64 from a list on the right. When the “seat” is selected, a menu of seat options 66 is opened to the left and the user 10 can then select the desired seat type and drag it onto the interior space 62, placing it where and in the orientation desired. 3D visualization 68 of the car design is presented for the user's convenience. The Interactive Design Assistant 70 guides the user 10 through the design process. It may also provide hints and feedback to the user. The menu 118 provides access to other modules and options that the system supports.

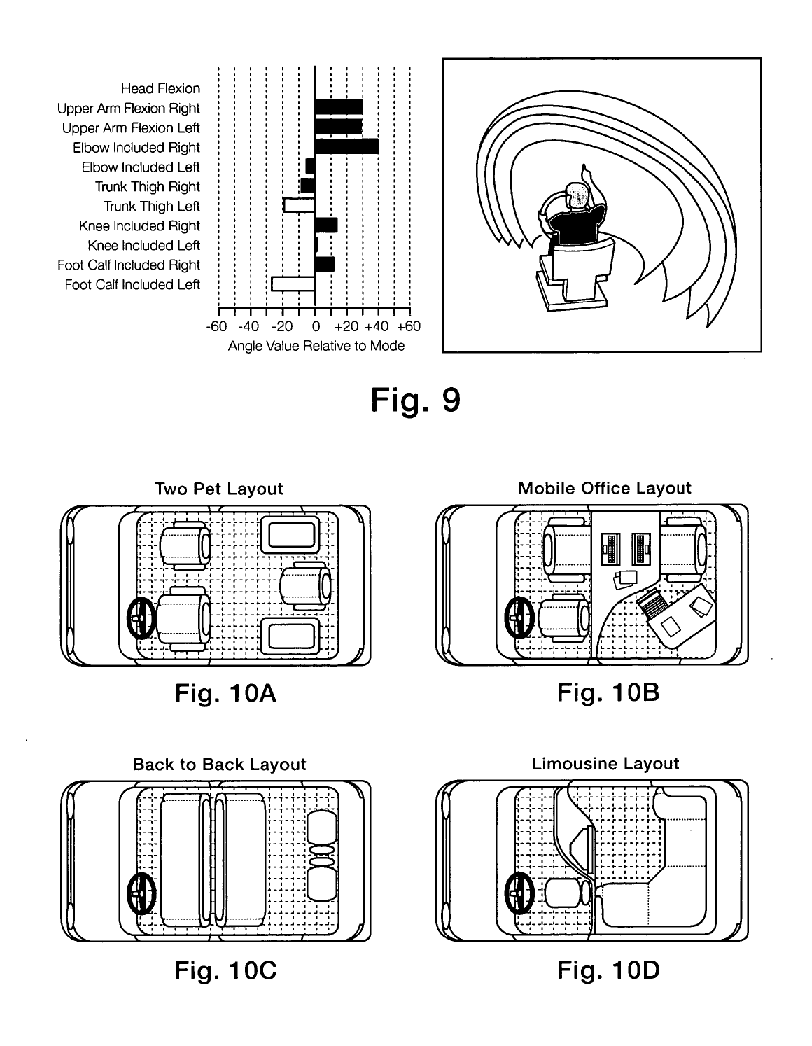

The subject method recognizes that different people can be simulated in different environments performing different tasks. Therefore, the method is capable of calculating a comfort level of each posture of the driver and of other occupants of the automobile (e.g., a passenger in the back seat). Body postures can be displayed visually for different body parts, as shown in FIG. 9. The images can be even displayed as animation sequences generated by software that is commercially available (e.g., Jack from UGS). An analog display may depict estimations made by the system as to whether certain placed components are within easy reach. For example, dark bars on the left panel may indicate that the buyer's joint is estimated to be within comfort parameters, while light bars may indicate that the person in the simulation is performing a task that is estimated to be outside his/her comfort limits.

FIGS. 10A-D show several examples of car interiors created with the method described in this invention. These exemplary designs begin to illustrate how a vehicle interior can be arranged to accommodate the personalized needs of different people. For example, FIG. 10A suggests a layout for a user 10 who expects to frequently transport two dogs. FIG. 10B might represent a layout for a traveling sales person or business executive. FIG. 10C is an interior arrangement that may be indicative of someone that routinely transports many people, such as a large family or a sports team. FIG. 10D depicts a proposed limousine configuration. Of course, the number of alternative configurations is limited only by the available choices and their placement options within the interior space.

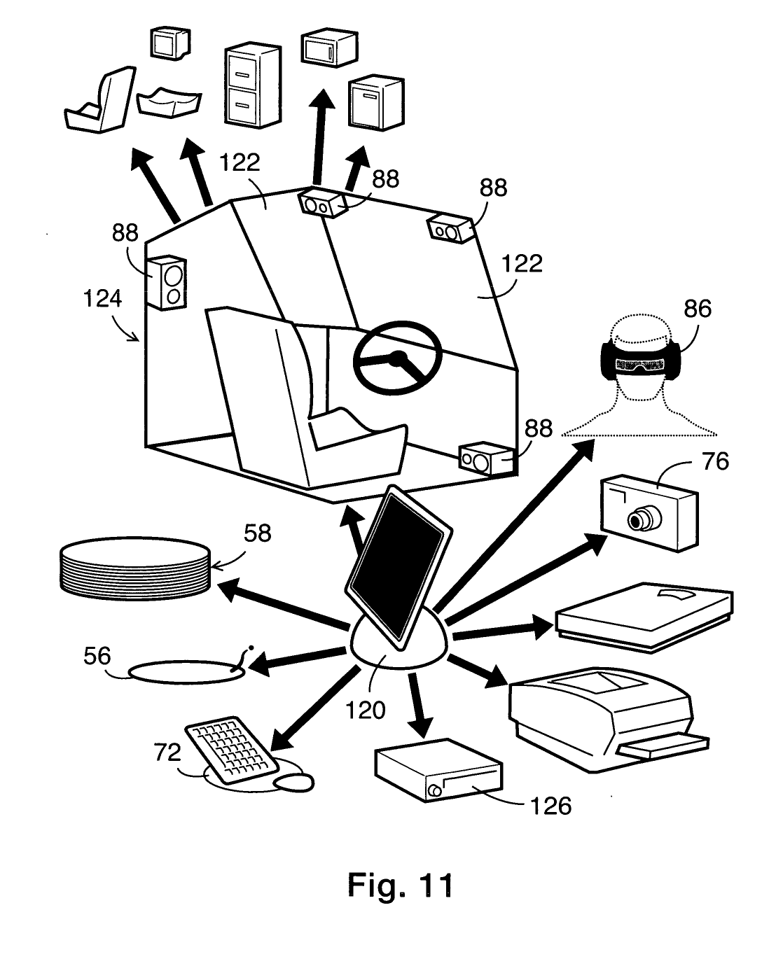

FIG. 11 graphically shows the apparatus of the subject invention which includes the computer 120 for hosting the software package developed to implement the method described above, a screen 122 displays the design results and simulations 86 of the human model in the car, and input devices 72, or a camera 76 or a scanning device, takes photos of the buyer's dimensions needed to implement the method. The apparatus of FIG. 11, with the software of the disclosed method, may be deployed at dealerships where an experienced professional assists the buyer 10 to operate the system efficiently. However, the software may be also available at other places or accessible through the Internet 56. The system will connect to a database that can be local, central, distributed, replicated or otherwise managed and synchronized.

The apparatus can connect to advanced interactive options such as a surround sound system 88 and 3D visualization options such as VR glasses 86. Several screens 122 can be attached to the system to improve visualization options and may be supported by more than one computer 120. The car simulator 84 in which the customer can sit in and experience the new environment, possibly in a dealership, can be attached to the system. The car simulator 84 can be enhanced by physically adding components that can be easily rearranged within its interior. Such reconfiguration of the simulator 84 interior will allow the customer 10 to experience his or her custom-designed car interior. Haptic devices such as a force feedback steering wheel can be used to give the customer 10 a realistic driving experience within the designed interior simulation.

Once a design is completed and saved by the system, the design together with the driver's simulation may be recorded on a suitable portable storage medium such as a CD or DVD or flash drive. The disc or flash drive can be given to the buyer 10 so that the simulation can be re-played at his/her home or in other places such as at the motor vehicle bureau or an insurance agent's office. A disc (or other portable storage medium) burner/reader 126 for this purpose is depicted in FIG. 11.

The business method of this invention is based on allowing the buyer 10 to design the interior of the purchased vehicle. This business method assures sales based on an elevated value of the product as perceived by the customer 10, and possibly also by other people who are aware of the design.

The manufacturer, prior to the sale, designs the car interior basic modules, but the final tailored, personalized design is done with the customer 10 input after the sale transaction of the automobile. Therefore, the actual business sequence of this method is: Design(A)-Sell-Design(P)-Make, where A stands for the product architecture design phase and the various modules that can be installed in the interior space of the automobile, and P stands for the personalized, final design phase in which the customer is involved.

Using this method yields the following advantages: A personalized car that is preferred by the customer as having added value compared to other products; a personalized car that fits the customer's height (so he/she can see the road conveniently) and the reach of his/her hands, having added safety and value compared to other products; a reconfigurable interior that enables the customer to reconfigure the car when his/her requirements change; a manufacturer that is more competitive by giving the customer exactly what the customer wants and needs; and a manufacturer/dealer that can maintain an enduring personal relationship with the customer, enabling the customer to reconfigure the car when his/her requirements change over time.

Another aspect of the subject business method is selling open-ended products that could be reconfigured by the buyer 10 in the future to accommodate future changing needs, budget constraints, and preferences. Geographical distance becomes important for rapid delivery of the product. Thus, this methodology will allow retaining manufacturing jobs in a home country or region. This can create a new domestic industry for reconfiguration of automobile interiors with great value to the local/national economy.

The Interactive Design Domain System 26 enables the subject business method, wherein the unique design of the customer 10 is considered as a product by itself. If the manufacturer chooses, it is possible to guarantee the uniqueness of a one-of-a-kind interior design and configuration (at the sale time) and set a higher selling price. The manufacturer can allow customers 10 to own a design, possibly for a price, and limit the number of copies of the same design or guarantee its uniqueness. The owner of the design may advertise the design, and pass ownership of the design, possibly for a price. When a design is declared as unique, the manufacturer guarantees that it will not manufacture a car with an identical design unless the owner consents. The system of this invention will retain the designs in a database for the entire lifetime of the product and beyond to guarantee uniqueness of its designs. With such support, both the manufacturer and the customer 10 will benefit and a new market of original equipment car designs may be made possible.

Customers with experience operating the system may design interiors using the system. Then they can negotiate with the manufacturer to declare them unique or a limited edition, and then sell this design to other customers for an agreed price in an after-market transaction. The system can be enabled with a title tracking feature to support such transfer of ownership in the design. Customers may even be encouraged to buy several designs in advance to support evolution of the car reconfiguration. This will aid the manufacturer to maintain a long term, enduring relationship with the customer 10.

The manufacturer can profit from selling the designs themselves and giving the option to manufacture the design. Payment may be made a long time ahead of actually manufacturing the product. The manufacturer can promote components, control the price of components and their combinations to conform to cash flow, supply chain, and inventory needs. One example for such process is that a famous celebrity will use the system to design a car. After the car is designed, if allowed by the manufacturer, the celebrity chooses to declare the car as unique. The manufacturer will then state the price for this specific design. If the celebrity chooses to pay this price, the design will become his/her property. From this point on, the manufacturer will not allow any other buyer 10 to design the same car via a similarity rule check in the Interactive Design Domain System. The celebrity then may choose not to actually order the manufactured car and instead sell the design to other customers for a higher price. After advertising and negotiation, the design is sold to another customer and transferred through the system. Then the new customer chooses to manufacture the car and the car is manufactured and delivered to this final customer. This car will be unique and another one will not be manufactured without the consent of the design owner. The manufacturer will control many aspects such as duration of the contract for uniqueness, when and how uniqueness can be offered and for what price, and the rules deciding on similarity of designs.

This invention deals with the design of the interior of automobiles such as but not including luxury cars, minivans, sedans and SUVs. There is a set of modules (e.g., different car seats, shelves, entertainment equipment, microwaves, small refrigerators, panels, lights, handles, dog baskets, etc.) that the customer will have to select from and compose according to his/her preferences, subject to safety constraints. As a result, the interior of cars of the same car model will look very different from each other.

The requirements of a woman with two small children sitting in the back of the car and driving in the city are different than those of say a businesswoman who takes long trips and would like a small refrigerator in the car. An old person who is usually sitting in the back would like to have a comfortable seat and not a 3-passenger bench. A short man would like a different design of the instrument panel (selected from a set of given modules) than might a tall man that can reach further features in the panel. Some people might like to have a folding shelf built into the seat or dash ahead, like in airplanes, so they could work with a laptop during long trips while somebody else is driving.

Furthermore, this invention opens the door for a new business method of reconfigurable interiors of vehicles that will go beyond folding seats to the removal and replacement of seats according to the changing needs of its users. For example, installing a small fridge instead of a car seat for long trips on hot days is possible with this invention.

This invention assumes that the interior of the car is an open space with numerous placement availabilities. The customer will look at a computer monitor either at the dealership (where he/she can be assisted by an experienced system operator) or at his/her home (with the aid of the Internet) and design the interior of his/her car.

A main challenge is how to enable a potential buyer 10 who is inexperienced in design to perform design tasks that are usually performed by a professional engineer, or a team of engineers, artists and other professionals. The inexperienced buyer 10 who designs a car interior may not be able to visualize the resulting design, nor appreciate the complexity involved with the design, which includes compliances to safety regulations, geometry constraints that allows enough leg space for example, and functional constraints (e.g., power to operate equipment). Therefore, a subsequent challenge is how to provide an immediate feedback to the buyer 10 so he/she will not be disappointed upon taking possession of the ordered product. This is a key to the success of the personalization business method, because the customer cannot sit in the car and check the product that he/she is buying. A feedback is needed not only for checking the general appearance and arrangement of the interior, but also for testing whether the various dimensions of the interior design fit the buyer's body dimensions (e.g., enough leg space, convenient reachability to panel controls). Yet, another challenge is to verify if there is enough geometric clearance among components (to open a refrigerator door, for example). Safety must be thoroughly checked at the design stage, which is another challenge.

Therefore, needed inputs in this invention are dimensions of the driver's body, such as arm length of the driver and his/her height, as well as those dimensions of frequent passengers. The apparatus of the invention must show a 3-D or a virtual reality image of the interior space and lead the customer 10 through step-by-step selection of the modules (seats, panels, etc.) from a given database library. At each step, safety, functional and geometric constraints must be checked.

The business advantage of this method is the value perceived by the customer; it has been confirmed that perception counts and does sell products. Yet, another business advantage is that it is possible to guarantee the uniqueness of a particular interior design and configuration (at the sale time) and ask for additional payment for this uniqueness.

To summarize, this invention enables the auto industry to move toward products tailored exactly to customer needs, budget, preferences, and body dimensions. The invention also enables open-ended products that can be reconfigurable by users as their needs change, which will open a new industry of reconfigurable vehicle interiors that is not adversely affected by globalization.

The invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that within the scope of the appended claims, the invention may be practiced otherwise than as specifically described. The invention is defined by the claims.

What is claimed is:

1. A method for selecting and placing modular components within the interior space of an unfinished motor vehicle by an individual retail buyer of the vehicle, said method comprising the steps of:
storing a plurality of vehicle interior space choices, each space choice having a plurality of possible discrete placement locations;
selecting one interior space from the plurality of stored space choices;
storing a plurality of modular component choices in an electronic database library;
selecting one component from the plurality of component choices in the library;
placing the selected component in the selected interior space in one discrete placement location;
simulating the interior space in a scaled depiction on a Graphic User Interface with the selected component positioned in the discrete placement location;
determining whether the placement of the selected component complies with a predetermined constraint; and
communicating non-compliance with the predetermined constraint directly to the buyer as feedback information.

2. The method of claim 1 further including the step of measuring at least one anthropometric dimension of the buyer.

3. The method of claim 2 further including the step of simulating the buyer on the Graphic User Interface as a scaled depiction within the interior space and seated a driving position while interacting with the selected component.

4. The method of claim 3 further including the steps of measuring at least one anthropometric dimension of a passenger, and simulating the passenger on the Graphic User Interface as a scaled depiction within the interior space.

5. The method of claim 2 further including the steps of mathematically estimating an interaction comfort between the buyer and the component based on the anthropometric dimension, and reporting the estimation directly to the buyer as an analog measurement.

6. The method of claim 2 wherein said step of measuring includes extracting the anthropometric information from an image of the buyer.

7. The method of claim 2 wherein said step of measuring includes allowing the buyer to enter and edit their anthropometric information through the Graphic User Interface.

8. The method of claim 1 wherein said step of communicating non-compliance includes providing the buyer with at least one suggestion to modify the selection and placement of the modular components within the selected interior space to achieve compliance with the predetermined constraint.

9. The method of claim 1 wherein said step of placing the selected component includes changing the orientation of the component within the selected interior space.

10. The method of claim 1 wherein said step of determining whether the placement of the selected component complies with a predetermined constraint includes selecting a constraint from the group including: safety constraints, geometry constraints and functional constraints.

11. The method of claim 10 wherein step of determining whether the placement of the selected component complies with a predetermined constraint includes consulting safety rules for pluralities of the component choices and their respective discrete placement options within the selected interior space.

12. The method of claim 1 further including the step of selecting a second component from the plurality of component choices in the library; placing the selected second component in the selected interior space in a second discrete placement location; simulating the interior space in a scaled depiction on a Graphic User Interface with the second selected component positioned in the second discrete placement location; determining whether the placement of the second selected component complies with a predetermined constraint; and communicating non-compliance with the predetermined constraint directly to the buyer as feedback information.

13. The method of claim 12 wherein said step of determining whether the placement of the second selected component complies with a predetermined constraint includes the step of analyzing a functional constraint in relation to the first selected component.

14. The method of claim 3 further including the steps of recording the simulation of the buyer interacting with the selected component on a portable storage medium, and providing the portable storage medium to the buyer.

15. A method for designing and personalizing the selection and placement of modular components within the interior space of an unfinished motor vehicle passenger compartment, said method comprising the steps of:
providing a retail motor vehicle buyer having at least one anthropometric characteristic;
measuring the buyer's anthropometric characteristic;
providing a Graphic User Interface of the type capable of displaying a scaled graphical representations of physical objects;
storing a plurality of modular component choices in an electronic database library;
selecting one component from the plurality of component choices in the library;
positioning the selected component in the interior space in one discrete placement location;
displaying on the Graphic User Interface a dimensionally scaled graphical representation of the selected component in the discrete placement location in the interior space;
displaying on the Graphic User Interface a dimensionally scaled graphical representation of the buyer in a seated driving position in the interior space;
calculating the minimum distance between the buyer and the component based on the measured anthropometric characteristic;
displaying the calculated minimum distance on the Graphic User Interface;
and re-positioning the selected component within the interior space to another discrete placement location if the calculated minimum distance is deemed unsatisfactory.

16. The method of claim 15 further including the steps of mathematically estimating an interaction comfort between the buyer and the component based on the anthropometric characteristic, and reporting the estimation directly to the buyer as an analog measurement.

17. The method of claim 15 wherein said step of measuring includes extracting the anthropometric characteristic from an image of the buyer.

18. The method of claim 15 wherein said step of measuring includes allowing the buyer to enter and edit information about their anthropometric characteristic through the Graphic User Interface.

19. The method of claim 15 wherein said step of placing the selected component includes changing the orientation of the component within the interior space.

20. The method of claim 15, further including the step of determining whether the placement of the selected component complies with a predetermined constraint; and communicating non-compliance with the predetermined constraint directly to the buyer as feedback information.

21. The method of claim 20 wherein said step of communicating non-compliance includes providing the buyer with at least one suggestion to modify the selection and placement of the modular components within the interior space to achieve compliance with the predetermined constraint.

22. The method of claim 21 wherein step of determining whether the placement of the selected component complies with a predetermined constraint includes consulting safety rules for pluralities of the component choices and their respective discrete placement options within the interior space.

23. The method of claim 20 further including the step of selecting a second component from a plurality of component choices in the library; placing the selected second component in the interior space in a second discrete placement location; simulating the interior space in a scaled depiction on a Graphic User Interface with the second selected component positioned in the second discrete placement location; determining whether the placement of the second selected component complies with a predetermined constraint; and communicating non-compliance with the predetermined constraint directly to the buyer as feedback information.

24. The method of claim 23 wherein said step of determining whether the placement of the second selected component complies with a predetermined constraint includes the step of analyzing a functional constraint in relation to the first selected component.

25. A business method for conducting a vehicle business transaction with an individual retail buyer of a motor vehicle, said method comprising the steps of:
providing the buyer with a vehicle interior space having a plurality of possible discrete placement locations;
providing the buyer with a plurality of modular component choices;
soliciting the buyer to select and place at least one component within the interior space of the motor vehicle prior to the vehicle being manufactured;
determining whether the buyer's placement of the selected component complies with a predetermined constraint; and
communicating non-compliance with the predetermined constraint directly to the buyer as feedback information.

26. The method of claim 25 further including the steps of: measuring at least one anthropometric characteristic on the buyer; calculating the minimum distance between the buyer and the selected component based on the measured anthropometric characteristic and different poses of the simulated buyer; and communicating the calculated minimum distance directly to the buyer.

27. The method of claim 26 further including the step of soliciting the buyer to re-position the selected component within the interior space to another discrete placement location if the calculated minimum distance is unsatisfactory.

28. The method of claim 25 wherein the business transaction is a lease of the vehicle to the buyer prior to the vehicle being manufactured.

29. The method of claim 25 wherein the business transaction is a sale of the vehicle to the buyer prior to the vehicle being manufactured.

30. The method of claim 25 further including the step of re-configuring the selected component within the interior space after the vehicle has been manufactured.

31. The method of claim 30 further including the step of determining whether the re-configured interior space complies with the predetermined constraint; and communicating non-compliance with the predetermined constraint as feedback information.

32. The method of claim 30 wherein said step of re-configuring includes selecting and placing a new modular component within the interior space of the motor vehicle, further including the steps of completing said step of re-configuring, and automatically ordering the new modular component from a supplier.

33. The method of claim 30 wherein said step of re-configuring includes the steps of completing said step of re-configuring, and automatically scheduling the re-configuration process with a professional service provider.

34. A business method for conducting a vehicle business transaction between a seller and an individual retail buyer to guarantee a unique motor vehicle, said method comprising the steps of:
providing the buyer with a vehicle interior space having a plurality of possible discrete placement locations;
providing the buyer with a plurality of modular component choices;
soliciting the buyer to select and place at least one modular component in a discrete placement location within the interior space of the motor vehicle prior to the vehicle being manufactured;
completing the vehicle interior design;
making a record of the completed vehicle interior design;
and excluding the completed vehicle interior design from future vehicles offered by the seller to other buyers.

35. The method of claim 34 further including the step of searching historical records for identical vehicle interior designs prior to said step of completing the vehicle interior design.

36. The method of claim 35 wherein said step of excluding the completed vehicle interior design occurs only after a predetermined number of identical vehicle interior designs have been recorded thereby guaranteeing a limited plural number of the identical vehicle interior designs.

37. An apparatus for selecting and placing modular components within the interior space of an unfinished motor vehicle by an individual retail buyer of the vehicle, said apparatus comprising:
a computer storage device for storing a plurality of vehicle interior space choices, each space choice having a plurality of possible discrete placement locations;
means for selecting one interior space from the plurality of stored space choices;
a computer storage device for storing a plurality of modular component choices in an electronic database library;
means for selecting one component from the plurality of component choices in the library;
means for placing the selected component in the selected interior space in one discrete placement location;
means for simulating the interior space in a scaled depiction on a Graphic User Interface with the selected component positioned in the discrete placement location;
means for determining whether the placement of the selected component complies with a predetermined constraint; and
feedback means for communicating non-compliance with the predetermined constraint directly to the buyer.
